(19) United States
(12) Patent Application Publication
(10) Pub. No.: US 2010/0254524 A1
(43) Pub. Date: Oct. 7, 2010

(54) PHONE NAME SERVICE

(76) Inventors: Yeonchul Kim, Lynnwood, WA (US); Tony H. Kim, Lynnwood, WA (US)

Correspondence Address: Ruttler IP Law PLLC;One Union Square, 600 University Street, Suite 1919, Seattle, WA, 98101, US

(21) Appl. No.: 12/465,095

(22) Filed: May 13, 2009

Related U.S. Application Data
(60) Provisional application No. 61/167,031, filed on Apr. 6, 2009.

(51) Int. Cl. H04M 3/42

(52) U.S. Cl. 379/201.02

(57) ABSTRACT

This invention relates generally to software, and more specifically, to systems and methods for providing a phone name service. In one embodiment, the invention includes a software application, the software application configured to perform the steps comprising receiving a phone name; receiving a phone number; and storing the phone number in association with the phone name, wherein the software application is associated with a computer readable media. In one particular embodiment, the phone name is alphanumerical. In another particular embodiment, the alphanumerical phone name is not limited to a length of the phone number. In a further particular embodiment, the alphanumerical phone name is not limited to characters corresponding to digit keys of the phone number. In a further embodiment, the software application is further configured to perform the steps comprising receiving a request for the phone number using the phone name; retrieving the phone number associated with the phone name; and communicating the phone number. In one particular embodiment, the request for the phone number using the phone name is received from a phone company and the phone number is communicated to the phone company for establishing a call using the phone number. In a further particular embodiment, the request for the phone number using the phone name is received from a calling device and the phone number is communicated to the calling device for establishing a call through a phone company using the phone number.

### PRIORITY CLAIM

This application claims the benefit of provisional patent application Ser. No. 61/167,031 filed Apr. 6, 2009 (our ref. YKIM-1-1001). The foregoing application is incorporated by reference in its entirety as if fully set forth herein.

### FIELD OF THE INVENTION

This invention relates generally to software, and more specifically, to systems and methods for providing a phone name service.

### SUMMARY

This invention relates generally to software, and more specifically, to systems and methods for providing a phone name service. In one embodiment, the invention includes a software application, the software application configured to perform the steps comprising receiving a phone name; receiving a phone number; and storing the phone number in association with the phone name, wherein the software application is associated with a computer readable media. In one particular embodiment, the phone name is alphanumerical. In another particular embodiment, the alphanumerical phone name is not limited to a length of the phone number. In a further particular embodiment, the alphanumerical phone name is not limited to characters corresponding to digit keys of the phone number. In a further embodiment, the software application is further configured to perform the steps comprising receiving a request for the phone number using the phone name; retrieving the phone number associated with the phone name; and communicating the phone number. In one particular embodiment, the request for the phone number using the phone name is received from a phone company and the phone number is communicated to the phone company for establishing a call using the phone number. In a further particular embodiment, the request for the phone number using the phone name is received from a calling device and the phone number is communicated to the calling device for establishing a call through a phone company using the phone number.

### BRIEF DESCRIPTION OF THE DRAWINGS

Embodiments of the present invention are described in detail below with reference to the following drawings:

FIG. 1 is a system diagram for implementing a phone name service, in accordance with an embodiment of the invention;

FIG. 2 is a flow diagram of a method performed by a software application of a phone name service, in accordance with an embodiment of the invention;

FIG. 3 is a flow diagram of a method performed by a software application of a phone name service, in accordance with an embodiment of the invention;

FIG. 4 is a flow diagram of a method performed by a software application of a phone name service, in accordance with an embodiment of the invention;

FIG. 5 is a flow diagram of a method performed by a software application of a phone company for communicating with a phone name service, in accordance with an embodiment of the invention;

FIG. 6 is a flow diagram of a method performed by a software application of a calling device for communicating with a phone company, in accordance with an embodiment of the invention; and

FIG. 7 is a flow diagram of a method performed by a software application of a calling device for communicating with a phone name service, in accordance with an embodiment of the invention.

### DETAILED DESCRIPTION

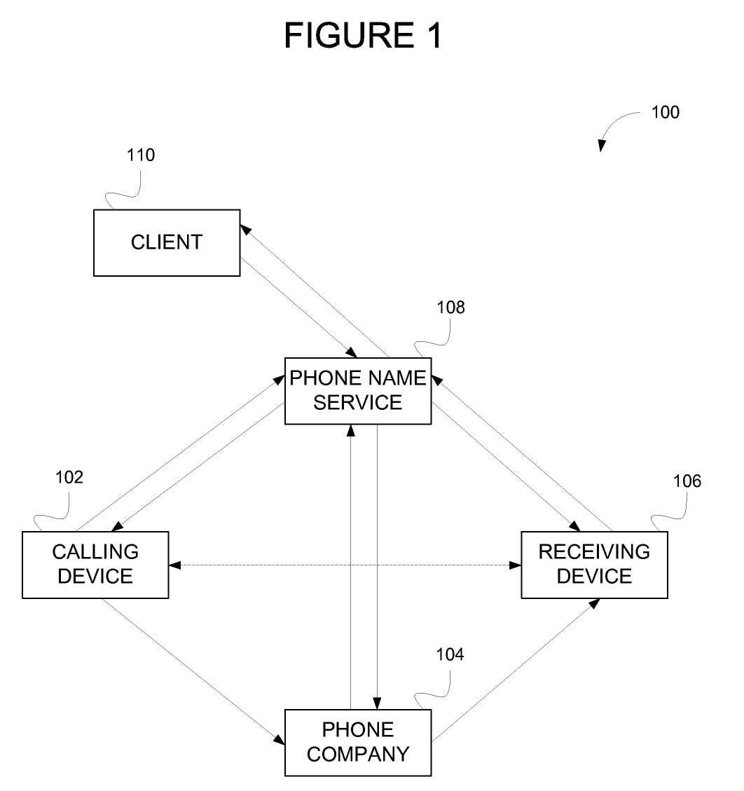

This invention relates generally to software, and more specifically, to systems and methods for providing a phone name service. Specific details of certain embodiments of the invention are set forth in the following description and in FIGS. 1-7 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a system diagram for implementing a phone name service, in accordance with an embodiment of the invention. In one embodiment, system 100 includes a calling device 102, a phone company 104, a receiving device 106, a phone name service 108, and a client 110. The calling device 102 is any device usable to establish communication with the receiving device 106. For example, the calling device 102 can include a telephone, a mobile phone, a personal digital assistant, an internet appliance, a computer, or some other similar device. Likewise, the receiving device 106 is any device usable to receive communication from the calling device 102. For example, the receiving device 106 can include a telephone, a mobile phone, a personal digital assistant, an internet appliance, a computer, or some other similar device. The client 110 is any device usable to communicate with the phone name service 108 via electronic, wireless, or audible communications. For example, the client 110 can include a personal computer, a laptop computer, a telephone, a mobile phone, a personal digital assistance, an internet appliance, or some other similar device. The phone company 104 is any entity usable to facilitate communications between the calling device 102 and the receiving device 106. For example, the phone company 104 can include AT&T, VERIZON, SPRINT, COMCAST, or some other similar entity. The phone name service 108 is a computer hardware implemented software application configured to implement various embodiments disclosed herein that is communicatably accessible to any of the calling device 102, the phone company 104, the receiving device 106, and the client 110. In some embodiments, the calling device 102, the phone company 104, the receiving device 106, the phone name service 108, or the client 110 can be combined or distributed to additional components. In some embodiments, any form of communication can be employed between the calling device 102, the phone company 104, the receiving device 106, and the client 110, such as analogue, digital, electronic, wireless, or satellite communication.

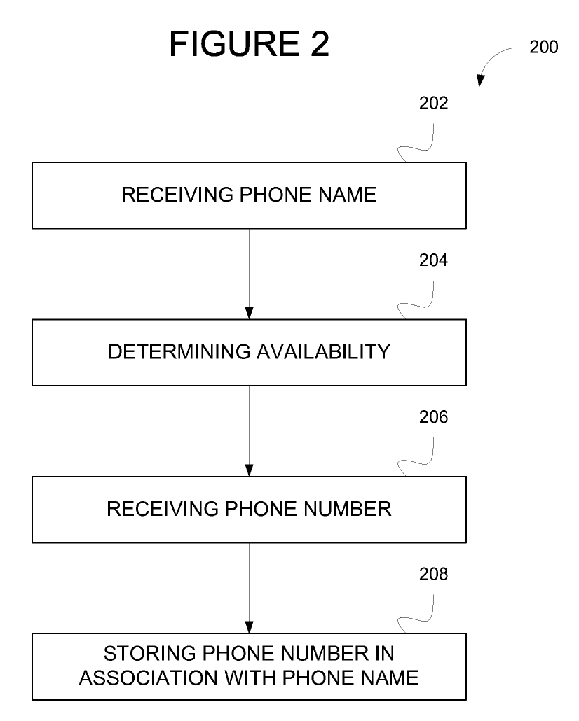

FIG. 2 is a flow diagram of a method performed by a software application of a phone name service, in accordance with an embodiment of the invention. In one embodiment, method 200 is performed by a software application of the phone name service 108. Method 200 includes receiving a phone name at 202, determining availability at 204, receiving a phone number at 206, and storing the phone number in association with the phone name at 208. As will be discussed more fully infra, the stored phone number is then retrievable using the phone name. For example, the receiving a phone name at 202 includes receiving alphanumerical characters such as GOOGLE. The determining availability at 204 includes determining whether GOOGLE has previously been stored or reserved by another. The receiving a phone number at 206 includes receiving numerical digits such as 650 253 0000, which is the phone number currently corresponding to the web search company Google, Inc. The storing the phone number in association with the phone name at 208 includes storing 650 253 0000 in association with GOOGLE in a database. The foregoing is just one example and many phone name and phone number combinations are possible. For instance, phone name and phone number combinations can include RUTTLER IP LAW and 206 838 6400; WHITE HOUSE and 202 456 1414; and BRIAN MOBILE and a mobile number for a man named Brian, SEATTLE-ROOFERS and an office number for a Seattle Roofing Company. Thus, any local, long distance, or international phone number can be stored with any phone name.

In some embodiments, the phone name is not restricted to a particular length nor does is it required to correspond to digit keys of the phone number. For example, the phone name can be only a single character or can be thirty or more characters. Additionally, the phone name can be GOOGLE despite the fact that the digit keys of 650 253 0000 do not correspond to the characters in GOOGLE.

In some embodiments, the phone name is a sound or a geographical location. For example, the phone name can be a spoken version of the words GOOGLE, RUTTLER IP LAW, WHITE HOUSE, BRIAN MOBILE, SEATTLE-ROOFERS, or any other sound. Accordingly, as discussed infra, a phone number can be retrieved by recognizing spoken words. Additionally, the phone name can be a geographical location such as GPS coordinates, cross-streets, an address, a landmark, a city, a state, or some other similar geographic location. Accordingly, as discussed infra, a phone number can be retrieved by a geographic location such as a restaurant at Broadway and Pike in Seattle.

In some embodiments, the receiving the phone name at 202 includes receiving a plurality of phone names and the storing the phone number in association with the phone name at 208 includes storing the phone number in association with the plurality of phone names. For example, the plurality of phone names can include GOOGLE, GOOGLE SEARCH, GOOGLE CO, GOOGLE.COM, or some other phone name all of which can be stored associated with 650 253 0000. Thus, the phone number can be retrieved by many different phone names.

In some embodiments, the receiving a phone number at 206 includes receiving a plurality of phone numbers and the storing the phone number in association with the phone name at 208 includes storing the plurality of phone numbers in association with the phone name. For example, the phone name can include YEONCHUL KIM and the plurality of phone numbers can include a home, mobile, and office phone number for a man named Yeonchul Kim. Thus, many different phone numbers can be retrieved by a single phone name. In some embodiments, the plurality of phone numbers can be priority ordered for callers with alternative numbers being attemptable. In one particular embodiment, the plurality of phone numbers can include security features to limit access, such as based upon a requesting entity identity.

In some embodiments, the phone name or the phone number are received electronically, wirelessly, or audibly via a client user interface on the calling device 102, the receiving device 106, or the client 110. For example, the phone name or the phone number can be spoken using the calling device 102 or can be entered on a keyboard using the client 110.

In some embodiments, the determining availability at 204 includes providing alternative suggestions when the phone name is unavailable, providing monitoring services for alerting when the phone name becomes available, or providing exchange services to facilitate acquisition of the phone name.

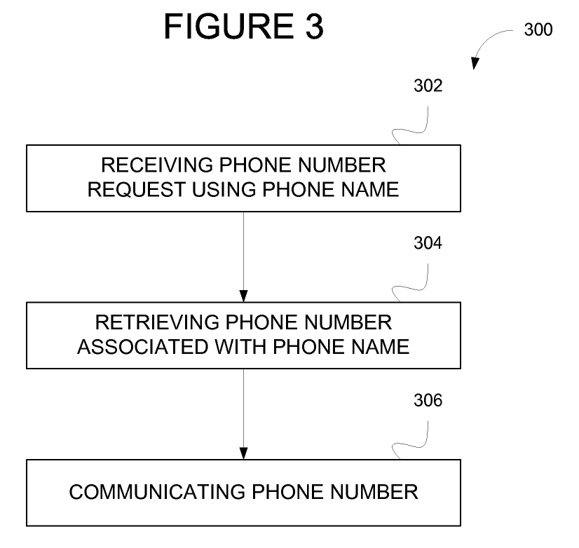

FIG. 3 is a flow diagram of a method performed by a software application of a phone name service, in accordance with an embodiment of the invention. In one embodiment, method 300 is performed by a software application of the phone name service 108. Method 300 includes receiving a phone number request using a phone name at 302, retrieving the phone number associated with the phone name at 304, and communicating the phone number at 306. For example, the receiving a phone number request using a phone name at 302 includes receiving a phone number request using GOOGLE, RUTTLER IP LAW, WHITE HOUSE, BRIAN MOBILE, SEATTLE-ROOFERS, or any other phone name. The retrieving the phone number associated with the phone name at 304 includes retrieving the phone number associated with GOOGLE, RUTTLER IP LAW, WHITE HOUSE, BRIAN MOBILE, SEATTLE-ROOFERS, or any other phone name. For instance, the phone number 650 253 0000 can be retrieved for GOOGLE, the phone number 206 838 6400 can be retrieved for RUTTLER IP LAW, the phone number 202 456 1414 can be retrieved for WHITE HOUSE, a mobile number for a man named Brian can be retrieved for BRIAN MOBILE, and an office number for a Seattle Roofing Company can be retrieved for SEATTLE-ROOFERS. The communicating the phone number at 306, includes communicating the retrieved phone number in response to the phone number request. For instance, the phone number 650 253 0000 can be communicated in response to the phone number request for GOOGLE; the phone number 206 838 6400 can be communicated in response to the phone number request for RUTTLER IP LAW; the phone number 202 456 1414 can be communicated in response to the phone number request for WHITE HOUSE; the mobile number for a man named Brian can be communicated in response to the phone number request for BRIAN MOBILE; and the office number for a Seattle Roofing Company can be communicated in response to the phone number request for SEATTLE-ROOFERS.

In some embodiments, the request for the phone number using the phone name is received from the phone company 104 having received the phone name within a call request from the calling device 102 and the phone number is communicated to the phone company 104 for establishing a call between the calling device 102 and the receiving device 106 using the phone number. For example, the calling device 102 can initiate a call request for GOOGLE to the phone company 104. The phone company 104 can then communicate GOOGLE to the phone name service 108, wherein the phone name service 108 receives GOOGLE, retrieves 650 253 0000, and communicates 650 253 0000 back to the phone company 104. The phone company 104 then establishes the call between the calling device 102 and the receiving device 106 using 650 253 0000 as the phone number.

In some embodiments, the phone number can be communicated to the phone company 104 for establishing a call between the calling device 102 and the receiving device 106 using the phone number and the phone number can be communicated to the calling device 102 for reference. For example, 650 253 0000 can be communicated to the calling device 102 before, while, or after the call is established between the calling device 102 and the receiving device 106 using 650 253 0000 as the phone number.

In some embodiments, the phone number can be communicated to the phone company 104 for establishing a call between the calling device 102 and the receiving device 106 using the phone number and the phone number can be communicated to the calling device 102 for reference in association with supplemental information. For example, 650 253 0000 can be communicated to the calling device 102 in association with supplemental information before, while, or after the call is established between the calling device 102 and the receiving device 106 using 650 253 0000 as the phone number. The supplemental information can include additional contact information, such as a mailing address, a website address, an email address, alternative phone numbers, contact names, or other similar information, or can include other non-contact information such as a website, a menu, hours of operation, directions, or the like, all of which can be related to the phone number.

In some embodiments, method 300 further includes retrieving a phone name associated with a phone number of the calling device 102 and communicating the phone name associated with the phone number of the calling device 102 to the phone company 104 for caller ID purposes. For example, as describe supra, the calling device 102 can initiate a call request for GOOGLE to the phone company 104. The phone company 104 can then communicate GOOGLE to the phone name service 108, wherein the phone name service 108 receives GOOGLE, retrieves 650 253 0000, and communicates 650 253 0000 back to the phone company 104. Additionally, the phone company 104 can communicate the phone number of the calling device 102 as 206 838 6400 to the phone name service 108, wherein the phone name service 108 receives the phone number of the calling device 102 as 206 838 6400, retrieves a phone name associated with the phone number of the calling device 102 as RUTTLER IP LAW, and communicates the phone name associated with the phone number of the calling device 102 as RUTTLER IP LAW back to the phone company 104. The phone company 104 then establishes the call between the calling device 102 and the receiving device 106 using 650 253 0000 as the phone number and furnishes the phone name associated with the phone number of the calling device 102 as RUTTLER IP LAW to the receiving device 106 for caller ID purposes. Thus, the calling device 102 can request a call using GOOGLE and the receiving device 106 can receive the call along with a caller ID of RUTTLER IP LAW.

In some embodiments, the request for the phone number using the phone name is received from the phone company 104 having received the phone name as a DTMF translation of the phone name within a call request from the calling device 102 and the phone number is communicated to the phone company 104 for establishing a call between the calling device 102 and the receiving device 106 using the phone number. For example, the calling device 102 can initiate a call request for GOOGLE, which is converted into a DTMF translation by the calling device 102 and communicated to the phone company 104. The phone company 104 receives the DTMF translation and converts the DTMF translation to GOOGLE. The phone company 104 can then communicate GOOGLE to the phone name service 108, wherein the phone name service 108 receives GOOGLE, retrieves 650 253 0000, and communicates 650 253 0000 back to the phone company 104. The phone company 104 then establishes the call between the calling device 102 and the receiving device 106 using 650 253 0000 as the phone number. Alternatively, the phone company 104 receives the DTMF translation and communicates the DTMF translation to the phone name service 108, wherein the phone name service 108 receives the DTMF translation and coverts the DTMF translation to the phone name, such as GOOGLE. The phone name service 108 then retrieves the phone number associated with the phone name, such as 650 253 0000, and communicates the phone number back to the phone company 104. The phone company 104 then establishes the call between the calling device 102 and the receiving device 106 using the phone number. For example, the following table can be used for providing a DTMF conversion/translation; although it should be clear that alternate methodologies can be employed and that DTMF translations are not always necessary.

TABLE 1

| | Char | | | | | | | | | |
|---|---|---|---|---|---|---|---|---|---|---|
| | 1 | 2 | A | B | C | 3 | D | E | F | 4 |
| DTMF | 1 | 2 | 22 | 222 | 2222 | 3 | 33 | 333 | 3333 | 4 |
| | Char | | | | | | | | | |
| | G | H | I | 5 | J | K | L | 6 | M | N |
| DTMF | 44 | 444 | 4444 | 5 | 55 | 555 | 5555 | 6 | 66 | 666 |
| | Char | | | | | | | | | |
| | O | 7 | P | Q | R | S | 8 | T | U | V |
| DTMF | 6666 | 7 | 77 | 777 | 7777 | 77777 | 8 | 88 | 888 | 8888 |

Char

| | 9 | W | X | Y | Z | * | 0 | # |
|---|---|---|---|---|---|---|---|---|
| DTMF | 9 | 99 | 999 | 9999 | 99999 | * | 0 | # |

In some embodiments, the request for the phone number using the phone name is received from the calling device 102 and the phone number is communicated to the calling device 102 for establishing a call through the phone company 104 using the phone number. For example, the calling device 102 can communicate GOOGLE to the phone name service 108, wherein the phone name service 108 receives GOOGLE, retrieves 650 253 0000, and communicates 650 253 0000 back to the calling device 102. The calling device 102 then establishes a call with the receiving device 106 through the phone company 104 using 650 253 0000 as the phone number.

In some embodiments, the phone number can be communicated to the calling device 102 for establishing a call through the phone company 104 using the phone number in association with supplemental information. For example, 650 253 0000 can be communicated to the calling device 102 in association with supplemental information before, while, or after the call is established between the calling device 102 and the receiving device 106 using 650 253 0000 as the phone number. The supplemental information can include additional contact information, such as a mailing address, a website address, an email address, alternative phone numbers, contact names, or other similar information, or can include other non-contact information such as a website, a menu, hours of operation, directions, or the like, all of which can be related to the phone number.

In some embodiments, the request for the phone name is received electronically, wirelessly, or audibly via a user interface associated with the client 110, the calling device 102, the receiving device 106. For example, the request can be received online via a website form, via a phone call, via a mobile phone software application, via mail, or some other methodology.

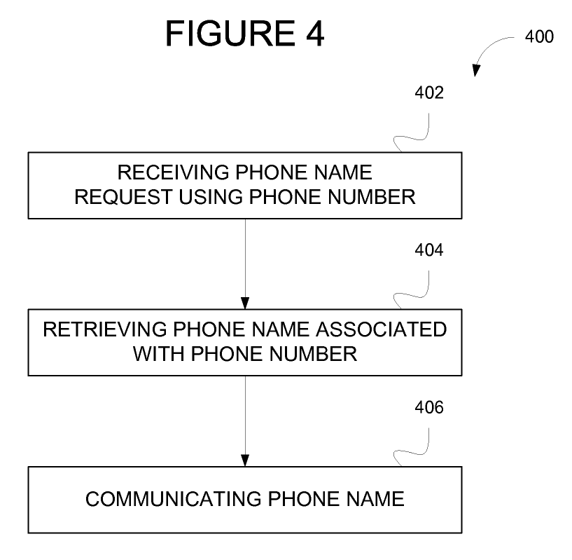

FIG. 4 is a flow diagram of a method performed by a software application of a phone name service, in accordance with an embodiment of the invention. In one embodiment, method 400 is performed by a software application of the phone name service 108. Method 400 includes receiving a phone name request using a phone number at 402, retrieving the phone name associated with the phone number at 404, and communicating the phone name at 406. For example, the receiving a phone name request using a phone number at 402 includes receiving a phone name request using 650 253 0000; 206 838 6400; 202 456 1414; a mobile number for a man named Brian; an office number for a Seattle Roofing Company; or any other phone number. The retrieving the phone name associated with the phone number at 404 includes retrieving the phone name associated with 650 253 0000; 206 838 6400; 202 456 1414; a mobile number for a man named Brian; an office number for a Seattle Roofing Company; or any other phone number. For instance, GOOGLE can be retrieved for the phone number 650 253 0000, RUTTLER IP LAW can be retrieved for the phone number 206 838 6400, WHITE HOUSE can be retrieved for the phone number 202 456 1414, BRIAN MOBILE can be retrieved for a mobile number for a man named Brian, and SEATTLE-ROOFERS can be retrieved for an office number for a Seattle Roofing Company. The communicating the phone name at 406, includes communicating the retrieved phone name in response to the phone name request. For instance, the phone name GOOGLE can be communicated in response to the phone name request for 650 253 0000; the phone name RUTTLER IP LAW can be communicated in response to the phone name request for 206 838 6400; the phone name WHITE HOUSE can be communicated in response to the phone name request for 202 456 1414; the phone name BRIAN MOBILE can be communicated in response to the phone name request for the mobile number for a man named Brian; and the phone name SEATTLE-ROOFERS can be communicated in response to the phone name request for the office number for a Seattle Roofing Company.

In some embodiments, the phone name request is received from the phone company 104, the calling device 102, the receiving device 106, or the client 110 for reverse look-up or caller ID purposes. In some embodiments, the phone name is communicated to the phone company 104, the calling device 102, the receiving device 106 or the client 110 for reverse look-up or caller ID purposes. In some embodiments, the phone name service 108 provides keyword, geographical location, or subject matter (e.g. legal services, restaurants, automotive shops, etc.) search functionality for phone names. In some embodiments, the search functionality of the phone name service 108 can be combined with advertisements, which may be related to the search parameters. In some embodiments, method 400 can be implemented in association with any other embodiment referenced herein.

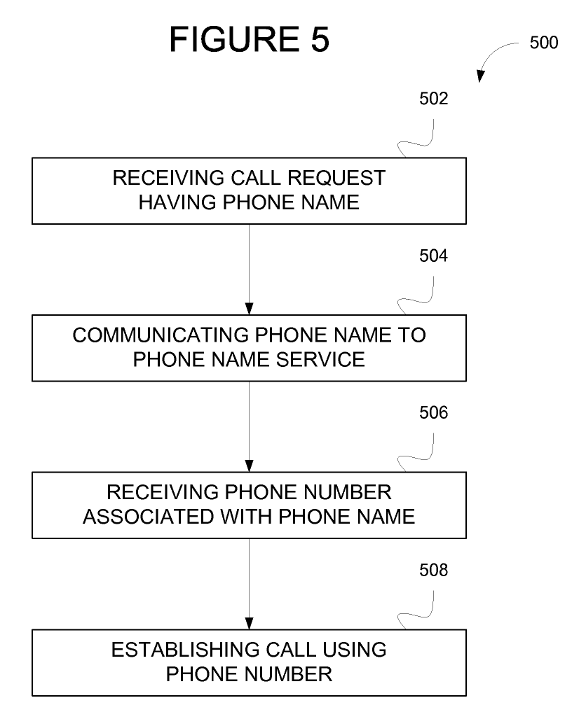

FIG. 5 is a flow diagram of a method performed by a software application of a phone company for communicating with a phone name service, in accordance with an embodiment of the invention. In one embodiment, method 500 is performed by a software application of the phone company 104. Method 500 includes receiving a call request having a phone name at 502, communicating the phone name to a phone name service at 504, receiving a phone number associated with the phone name at 506, and establishing a call using the phone number at 508. For example, the receiving a call request having a phone name at 502 includes receiving a call request from the calling device 102 having GOOGLE, RUTTLER IP LAW, WHITE HOUSE, BRIAN MOBILE, SEATTLE-ROOFERS, or any other phone name. The communicating the phone name to a phone name service at 504 includes communicating GOOGLE, RUTTLER IP LAW, WHITE HOUSE, BRIAN MOBILE, SEATTLE-ROOFERS, or any other phone name to the phone name service 108. The receiving a phone number associated with the phone name at 506 includes receiving the phone number associated with GOOGLE, RUTTLER IP LAW, WHITE HOUSE, BRIAN MOBILE, SEATTLE-ROOFERS, or any other phone name from the phone name service 108. For instance, the phone number 650 253 0000 can be received for GOOGLE, the phone number 206 838 6400 can be received for RUTTLER IP LAW, the phone number 202 456 1414 can be received for WHITE HOUSE, a mobile number for a man named Brian can be received for BRIAN MOBILE, and an office number for a Seattle Roofing Company can be received for SEATTLE-ROOFERS. The establishing a call using the phone number at 508 includes establishing a call between the calling device 102 and the receiving device 106 using the phone number received from the phone name service 108.

In some embodiments, the phone name is communicated to the phone name service 108 after automatically determining that the phone name requires translation into the phone number, such as through a unique identifier or a characteristic of the phone name like content or length. In some embodiments, method 500 can be implemented in association with any other embodiment referenced herein.

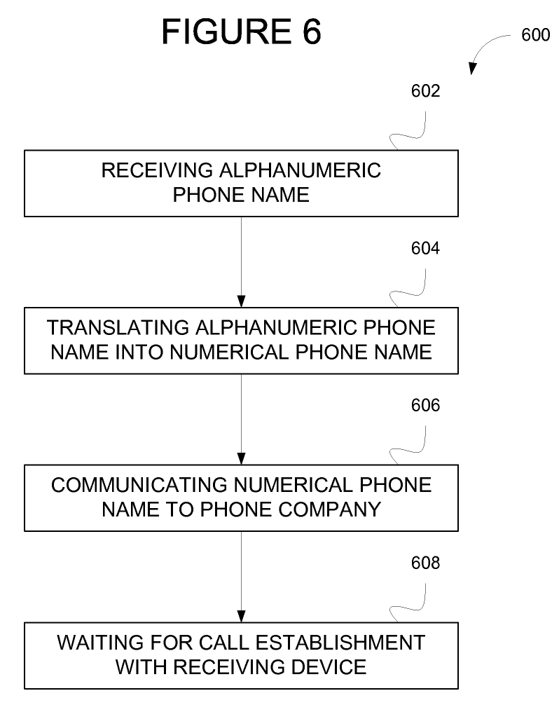

FIG. 6 is a flow diagram of a method performed by a software application of a calling device for communicating with a phone company, in accordance with an embodiment of the invention. In one embodiment, method 600 is performed by a software application of the calling device 102. Method 600 includes receiving an alphanumeric phone name at 602, translating the alphanumeric phone name into a numerical phone name at 604, communicating the numerical phone name to a phone company at 606, and waiting for a call establishment with a receiving device at 608. For example, the receiving an alphanumeric phone name at 602 includes the calling device 102 receiving GOOGLE, RUTTLER IP LAW, WHITE HOUSE, BRIAN MOBILE, SEATTLE-ROOFERS, or any other phone name. The translating the alphanumeric phone name into a numerical phone name at 604 includes the calling device 102 translating GOOGLE, RUTTLER IP LAW, WHITE HOUSE, BRIAN MOBILE, SEATTLE-ROOFERS, or any other phone name into a DTMF version of the phone name. For instance, the calling device 102 can use Table 1 supra to translate the phone name into a DTMF version of the phone name. The communicating the numerical phone name to a phone company at 606 includes communicating the DTMF version of the phone name to the phone company 104. The waiting for a call establishment with a receiving device at 608 includes waiting for the phone company 104 to retrieve the phone number associated with the phone name from the phone name service 108 and to establish a call between the calling device 102 and the receiving device 106 using the phone number.

In some embodiments, the alphanumeric phone name can be communicated to the phone company 104 without requiring a translation into a numerical phone name. In some embodiments, method 600 can be implemented in association with any other embodiment referenced herein.

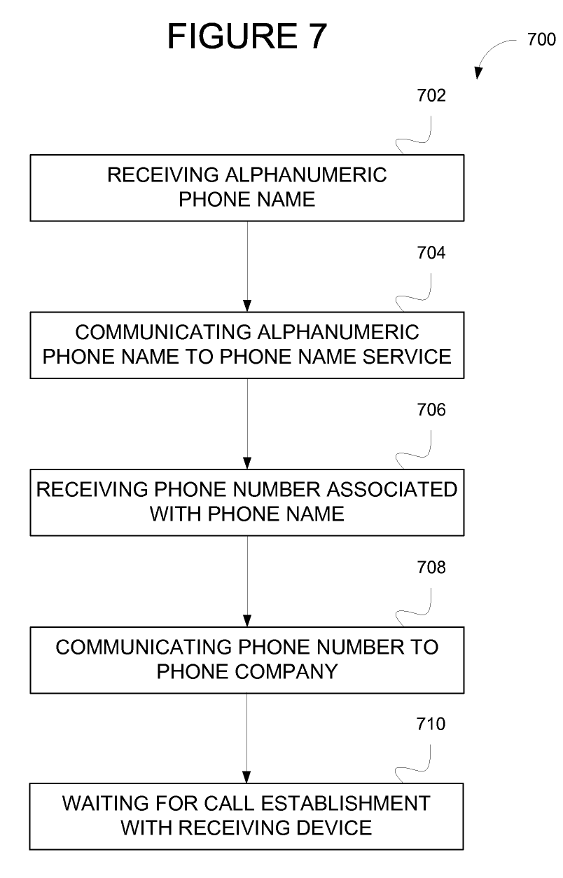

FIG. 7 is a flow diagram of a method performed by a software application of a calling device for communicating with a phone name service, in accordance with an embodiment of the invention. In one embodiment, method 700 is performed by a software application of a calling device 102. Method 700 includes receiving a phone name at 702, communicating the phone name to a phone name service at 704, receiving a phone number associated with the phone name at 706, communicating the phone number to a phone company at 708, and waiting for a call establishment with a receiving device at 710. For example, the receiving a phone name at 702 includes the calling device 102 receiving GOOGLE, RUTTLER IP LAW, WHITE HOUSE, BRIAN MOBILE, SEATTLE-ROOFERS, or any other phone name. The communicating the phone name to a phone name service at 704 includes the calling device 102 communicating GOOGLE, RUTTLER IP LAW, WHITE HOUSE, BRIAN MOBILE, SEATTLE-ROOFERS, or any other phone name to the phone name service 108. The receiving a phone number associated with the phone name at 706 includes the calling device 102 receiving a phone number associated with GOOGLE, RUTTLER IP LAW, WHITE HOUSE, BRIAN MOBILE, SEATTLE-ROOFERS, or any other phone name from the phone name service 108. For instance, the phone number 650 253 0000 can be received for GOOGLE, the phone number 206 838 6400 can be received for RUTTLER IP LAW, the phone number 202 456 1414 can be received for WHITE HOUSE, a mobile number for a man named Brian can be received for BRIAN MOBILE, and an office number for a Seattle Roofing Company can be received for SEATTLE-ROOFERS. The communicating the phone number to a phone company at 708 includes the calling device 102 using the phone number received at 706 to initiate a call through the phone company 104. The waiting for a call establishment with a receiving device at 710 includes the calling device 102 waiting for the phone company 104 to establish a call between the calling device 102 and the receiving device 106 using the phone number communicated at 708. In some embodiments method 700 can be implemented in association with any other embodiment referenced herein.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A software application, the software application configured to perform the steps comprising:
receiving a phone name;
receiving a phone number; and
storing the phone number in association with the phone name,
wherein the software application is associated with a computer readable media.

2. The software application of claim 1, wherein the storing the phone number in association with the phone name comprises storing the phone number in association with the phone name when the phone name has not previously been stored in association with another phone number.

3. The software application of claim 1, wherein the phone name is a sound or a geographical location.

4. The software application of claim 1, wherein the phone name is alphanumerical.

5. The software application of claim 4, wherein the alphanumerical phone name is not limited to a length of the phone number.

6. The software application of claim 4, wherein the alphanumerical phone name is not limited to characters corresponding to digit keys of the phone number.

7. The software application of claim 1, wherein the receiving a phone name comprises receiving a plurality of phone names and wherein the storing the phone number in association with the phone name comprises storing the phone number in association with the plurality of phone names.

8. The software application of claim 1, wherein the receiving a phone number comprises receiving a plurality of phone numbers and wherein the storing the phone number in association with the phone name comprises storing the plurality of phone numbers in association with the phone name.

9. The software application of claim 1, wherein the phone name or the phone number are received electronically, wirelessly, or audibly via a client user interface.

10. The software application of claim 1, wherein the software application is further configured to perform the steps comprising:
receiving a request for the phone number using the phone name;
retrieving the phone number associated with the phone name; and
communicating the phone number.

11. The software application of claim 10, wherein the request for the phone number using the phone name is received from a phone company and wherein the phone number is communicated to the phone company for establishing a call using the phone number.

12. The software application of claim 11, wherein the phone name is received from the phone company having received the phone name within a call request from a calling device.

13. The software application of claim 12, wherein the phone number is also communicated to the calling device for reference.

14. The software application of claim 12, wherein the phone number is also communicated to the calling device for reference in association with supplemental information.

15. The software application of claim 12, wherein the software application is further configured to perform the steps comprising:
retrieving a phone name associated with a phone number of the calling device; and
communicating the phone name associated with the phone number of the calling device to the phone company for caller ID purposes.

16. The software application of claim 12, wherein the phone name is received from the phone company having received the phone name as a DTMF translation of the phone name within a call request from a calling device.

17. The software application of claim 16, wherein the phone name is received from the phone company as a DTMF translation of the phone name.

18. The software application of claim 10, wherein the request for the phone number using the phone name is received from a calling device and wherein the phone number is communicated to the calling device for establishing a call through a phone company using the phone number.

19. The software application of claim 18, wherein the phone number is communicated to the calling device in association with supplemental information.

20. The software application of claim 10, wherein the request for the phone number using the phone name is received electronically, wirelessly, or audibly via a client user interface.

21. The software application of claim 1, wherein the software application is further configured to perform the steps comprising:
receiving a request for the phone name using the phone number;
retrieving the phone name associated with the phone number; and
communicating the phone name.
